(19) United States
(12) Patent Application Publication
(10) Pub. No.: US 2017/0013434 A1
(43) Pub. Date: Jan. 12, 2017

(54) METHOD, SYSTEM AND APPARATUS FOR EMERGENCY CALL HANDLING

(71) Applicant: REDKNEE INC., Mississauga (CA)

(72) Inventors: Ashid MOHAMMED, Bangalore (IN); Raghuvamshi THAKUR, Bangalore (IN)

(21) Appl. No.: 15/121,812

(22) PCT Filed: May 23, 2014
(86) PCT No.: PCT/CA2014/000446

§ 371 Date: Aug. 26, 2016

(51) Int. Cl. H04W 4/22; H04W 76/00

(52) U.S. Cl. CPC H04W 4/22; H04W 76/007; H04W 80/10

(57) ABSTRACT

A method, system and apparatus are provided for handling emergency calls at a policy server. The policy server receives a request to establish an emergency call for a mobile device, from a service provider server. The request is received in an external format. The policy server converts the request to an internal format, and processes the internal request to generate an internal answer. The internal answer indicates whether the emergency call is permitted or denied. The policy server converts the internal answer to the external format, and transmits the converted answer to the service provider server. When the emergency call is permitted, the policy server deploys one or more policy rules to a gateway server.

### FIELD

The specification relates generally to communications systems, and specifically to a method, system and apparatus for emergency call handling in a communications system.

### BACKGROUND

In some telecommunication networks, such as Long Term Evolution (LTE) networks, emergency calls are established either through interactions between the LTE core network and a packet-switched multimedia network, or over a circuit-switched network (in an operation referred to as circuit switched fallback). When a mobile device is served by a service provider whose network elements do not support certain standards defining the operation of the LTE and multimedia networks, that mobile device cannot establish an emergency call over the LTE and multimedia networks.

Further, some mobile devices are also not capable of communicating over circuit-switched networks, and thus the circuit-switched fallback procedure is also unavailable. Thus, such mobile devices become difficult or impossible to provide with emergency services.

### SUMMARY

According to an aspect of the specification, a method of establishing an emergency call at a policy control server is provided, comprising: receiving an emergency authorization request, for establishing an emergency call by a mobile device, from a service provider server in an external format; converting the emergency authorization request to an internal request message having an internal format; processing the internal request message to generate an internal answer message having the internal format, the internal answer message indicating whether the emergency call is permitted or denied; converting the internal answer message to an emergency authorization response message having the external format; transmitting the emergency authorization response message to the service provider server; and when the emergency call is permitted, deploying one or more policy rules to a gateway server.

According to another aspect of the specification, a policy server configured to perform the above method is provided. According to a further aspect of the specification, a non-transitory computer readable medium is provided storing a plurality of computer-readable instructions executable by a processor of the above policy server for implementing the above method.

### BRIEF DESCRIPTIONS OF THE DRAWINGS

Embodiments are described with reference to the following figures, in which:

FIG. 1 depicts a communications system, according to a non-limiting embodiment;

FIG. 2 depicts the policy server of the system of FIG. 1, according to a non-limiting embodiment;

FIG. 3 depicts modules of a policy application executed by the policy server if FIG. 2, according to a non-limiting embodiment;

FIG. 4 depicts a method of establishing an emergency call, according to a non-limiting embodiment;

FIG. 5 depicts configuration data stored by the policy server of FIG. 2, according to a non-limiting embodiment; and

FIG. 6 depicts a method of terminating an emergency call, according to a non-limiting embodiment.

### DETAILED DESCRIPTION OF THE EMBODIMENTS

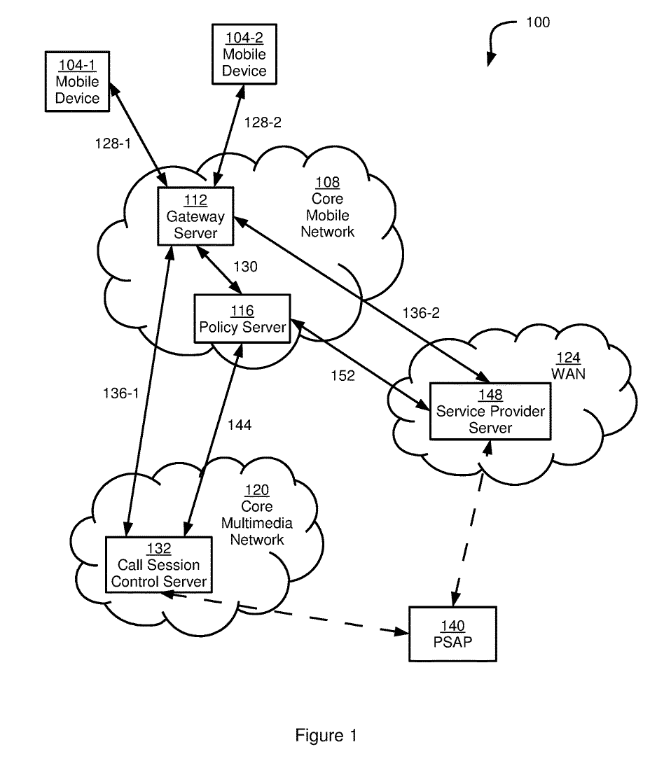

FIG. 1 depicts a communications system 100. System 100 includes a plurality of mobile devices, of which two examples, mobile device 104-1 and mobile device 104-2, are shown. Mobile devices 104-1 and 104-2 can be any of a variety of mobile computing devices, and thus each have hardware elements including a processing unit, volatile and non-volatile memory, network interfaces, as well as input and output devices (e.g. any suitable combination of displays, speakers, microphones, touch screens and the like). The processing units of mobile devices 104-1 and 104-2 execute programming instructions stored in memory for carrying out various functions, including the initiation of data communications over certain networks.

In the embodiments discussed herein, mobile device 104-1 is a cell phone or smart phone, able to connect to one or both of packet switched (e.g. Long Term Evolution (LTE)) and circuit switched (e.g. Global System for Mobile communications (GSM)) networks. Mobile device 104-2, on the other hand, is a machine-to-machine (MTM or M2M) computing device that is only capable of connecting to packet switched networks—that is, mobile device 104-2 lacks the network interface hardware necessary to communicate over circuit switched networks. Examples of MTM devices include devices mounted in automobiles or other vehicles for the purpose of anti-theft tracking, accident assistance or the like. Other examples of MTM devices will also occur to those skilled in the art.

In the present example, mobile devices 104-1 and 104-2 each include the necessary network interface hardware, and stored programming instructions, to communicate with a core mobile network 108. In the present example, core network 108 is structured according to the Long Term Evolution (LTE) standard set by the 3^{rd} Generation Partnership Project (3GPP). The features described herein may also be applied to other networks, as will be apparent to those skilled in the art.

Core network 108 includes a gateway server 112 and a policy server 116. In the present example, in which core network 108 is the LTE core network, gateway server 112 may also be referred to as a Packet Data Network Gateway (PDN Gateway or P-GW), while policy server 116 may also be referred to as a Policy and Charging Rules Function (PCRF). Certain features of a P-GW and a PCRF in an LTE network will be known to those skilled in the art from published 3GPP specifications. However, policy server 116 includes additional features, described herein, that extend beyond those set out in the 3GPP standards.

Other elements of core network 108 (such as a Mobility Management Entity, MME, and a Home Subscriber Server, HSS) can be implemented conventionally, and are therefore not shown herein for simplicity.

Gateway server 112, in brief, allows mobile devices 104-1 and 104-2 to access other data networks, including a core multimedia network 120 and a wide area network (WAN) 124. In the present example, core multimedia network 120 is an IP Multimedia Subsystem (IMS) network, and WAN 124 is the Internet. Mobile device 104-1 connects to gateway server 112 over a link 128-1, while mobile device 104-2 connects to gateway server 112 over a link 128-2. Links 128-1 and 128-2 traverse access network hardware such as base stations, which are not shown for simplicity of illustration. Having established communications with gateway server 112, each of mobile devices 104-1 and 104-2 may communicate with other network elements that provide services to which the mobile devices are subscribed.

Policy server 116 generates rules for communication sessions between mobile devices 104-1 and 104-2, and gateway 112. The nature of such rules is not particularly limited: the rules can define Quality of Service (QoS) parameters for each session, charging parameters for each session, and other parameters that will occur to those skilled in the art. Policy server 116 provides those rules to gateway server 112 over a link 130. Gateway server 112 then applies the rules to its communication sessions with mobile devices 104-1 and 104-2. The data carried by those communication sessions generally does not terminate at gateway server 112, but rather flows through gateway server 112 and terminates at a network element (or another mobile device) outside core network 108. The rules generated by policy server 116 can therefore be based not only on data stored within network 108, but also on data received from outside networks, as will be discussed in further detail below.

In the present example, mobile device 104-1 is a subscriber in multimedia network 120, and thus communicates with a call session control server 132 via gateway 112 and a link 136-1. Call session control server 132, in an IMS network, may be a conventional Proxy Call Session Control Server (P-CSCF) that participates in setting up incoming and outgoing media sessions for mobile device 104-1, such as voice over IP (VoIP or VoLTE) calls, including video calls. Those calls can include, for instance, an emergency call that terminates at a Public Safety Answering Point (PSAP) 140. As part of the establishment of such calls, session control server 132 can send data to policy server 116 over a link 144 that includes identifiers of mobile device 104-1, the service being requested (e.g. VoIP call), the destination for the call, and the like. Policy server 116 is configured to generate rules for deployment to gateway server 112 based on the data received over link 144 in addition to data (such as data from a Subscription Profile Repository (SPR)) available within network 108.

According to the LTE standard, session control server 132 must send the above-mentioned data to policy server 116 over link 144 using the known Rx protocol (an implementation of the Diameter protocol). The setup of calls, including emergency calls, for mobile device 104-1 through gateway 112 and call session control server 132 is well understood by those skilled in the art, as are the interactions between session control server 132 and policy server 116 (and PSAP 140, during emergency calls) during such call setup.

Mobile device 104-2, on the other hand, is not a subscriber in multimedia network 120 in the present example. Instead, mobile device 140-2 connects, via link 128-2, gateway 112, and a link 136-2, to a service provider server 148 in WAN 124. Server 148 may, for example, record data concerning the location and speed of an automobile in which mobile device 104-2 is mounted, for anti-theft tracking purposes.

Server 148 is connected to policy server 116 via a link 152. Link 152, however, is not based on the Rx protocol, as server 148 in the present embodiment is not capable of communicating using the Rx protocol. Server 148 may communicate with mobile device 104-2 and policy server 116 via a variety of protocols other than Rx, including Hyper Text Transfer Protocol (HTTP), Simple Object Access Protocol (SOAP), Session Initiation Protocol (SIP) and the like. It will now be apparent to those skilled in the art that session control server 132 is an example of an Application Function (AF) as defined by the 3GPP specifications (e.g. 3GPP TS 23.002). It will also now be apparent to those skilled in the art that server 148 may be considered a non-standard AF, in that it serves a mobile device and is connected to core network 108 like standard AFs, but does not comply with the 3GPP standards due to its inability to use the Rx protocol. Therefore, in the absence of the adaptations of policy server 116 to be discussed below, server 148 would be unable to provide certain services to mobile device 104-2, including emergency calls.

Mobile device 104-2 may generally not require voice or video calling services. However, in certain situations it may be necessary for occupants of the vehicle in which mobile device 104-2 is mounted to make an emergency call. However, because server 148 is unable to communicate using the Rx protocol, server 148 cannot send data to a conventional PCRF that is necessary for the PCRF to set rules at gateway 112 that are amenable to supporting a voice or video session. Further, because mobile device 104-2 cannot communicate over circuit switched networks, it is impossible to establish an emergency call using a Circuit Switched Fallback (CSFB) procedure familiar to those skilled in the art.

In order to support media sessions such as emergency calls for mobile device 104-2, policy server 116 includes certain features extending beyond the features of a conventional PCRF as defined by the 3GPP specifications (e.g. 3GPP TS 23.203, 29.212. 29.213, and 29.214). Policy server 116 therefore be described in greater detail below.

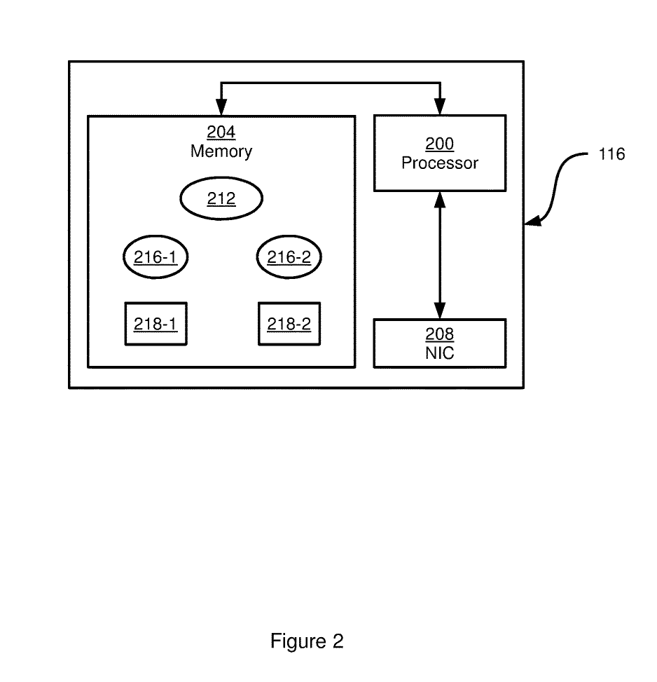

Turning to FIG. 2, certain internal components of policy server 116 are depicted. Policy server 116 includes a central processing unit (CPU) 200, also referred to herein as a processor 200, interconnected with a memory 204. Processor 200 and memory 204 are generally comprised of one or more integrated circuits (ICs), and can have a variety of structures, as will now occur to those skilled in the art (for example, more than one CPU can be provided).

Memory 204 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In the present example, memory 204 includes both volatile and non-volatile storage.

Processor 200 is also interconnected with one or more network interfaces, such as a network interface controller (NIC) 208, which allows policy server 116 to connect to other computing devices in networks 108, 120 and 124 (via links 130, 144 and 152). NIC 208 thus includes the necessary hardware to communicate over links 130, 144 and 152. Policy server 116 can also include input devices (not shown) interconnected with processor 200, such as a keyboard and mouse, as well as output devices (not shown) interconnected with processor 200, such as a display. In some embodiments, the input and output devices can be connected to processor 200 via NIC 208 and another computing device. In other words, input and output devices can be local to policy server 116, or remote.

Memory 204 stores a plurality of computer-readable programming instructions, executable by processor 200, in the form of various applications, and also stores various types of data for use during the execution of those applications. As will be understood by those skilled in the art, processor 200 may execute the instructions of one or more such applications in order to perform various operations defined within the instructions. In the description below, processor 200 or policy server 116 more generally are said to be “configured to” perform certain functions. It will be understood that policy server 116 is so configured via the processing of the instructions of the applications stored in memory 204.

Among the applications stored in memory 204 are a core policy application 212 and a plurality of plug-in applications, of which two examples are shown: plug-in 216-1 and plug-in 216-2. A larger or smaller number of plug-ins can be provided in memory 204. Memory 204 can contain one plug-in application for each service provider server communicating with policy server 116 that does not support the Rx protocol. In other embodiments, memory 204 can contain on plug-in application for each non-Rx protocol. That is, a given plug-in application can be employed to communicate with several service provider servers that use the same non-Rx protocol. Thus, in the present example, plug-in 216-1 corresponds to service provider server 148, while plug-in 216-2 corresponds to another service provider server (not shown). As will be described in greater detail below, plug-ins 216 (as they are collectively referred to) extend the functionality of core application 212 to allow policy server 116 to generate rules for gateway server 112 based on information received from server 148 or other similar servers that is not formulated according to the Rx protocol.

Memory 204 also stores a set of configuration data 218 corresponding to each plug-in 216. Thus, in the present example, two sets of configuration data are stored in memory 204: configuration data 218-1 and configuration data 218-2. Configuration data 218-1 and 218-2 can be stored in individual files, or together in a database in memory 204 with identifiers associating the appropriate configuration data with the appropriate plug-in. Other storage structures for configuration data 218 will also occur to those skilled in the art.

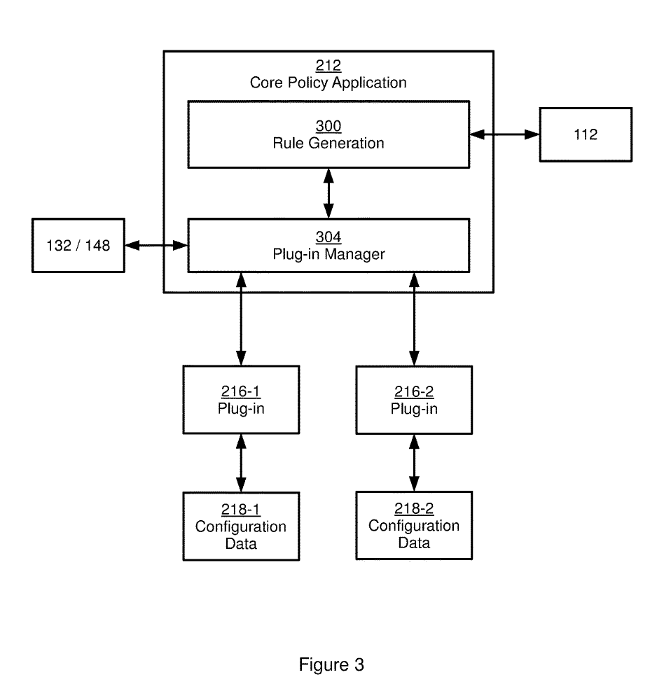

Turning now to FIG. 3, a schematic diagram of the components of application 212 is shown. Application 212 includes a rule generation module 300 and a plug-in manager module 304. Modules 300 and 304 comprise sets of programming instructions within core policy application 212 that each provide certain functions. In particular, rule generation module 300 receives data identifying a service that has been requested by a mobile device, as well as data identifying the mobile device itself, and generates rules for gateway server 112. The generation of rules in such a manner is known to those skilled in the art, and can also involve the retrieval of additional data by rule generation module 300 from a database such as an SPR (now shown) within network 108.

Core policy application 212 also includes a plug-in manager 304 in communication with rule generation module 300. Whereas rule generation module 300 in a conventional policy application would receive data directly from outside sources (such as session control server 132), in the present example plug-in manager 304 intermediates between rule generation module and external devices like session control server 132 and service provider server 148.

Plug-in manager 304 stores a registration record for each plug-in 216. Each registration record includes an identifier of the particular plug-in 216, and one or more characteristics of messages for which that plug-in 216 is to be executed. Thus, for example, plug-in manager 304 may store a registration record indicating that plug-in 216-1 is to be executed to handle any messages received at plug-in manager 304 that have originator or destination address corresponding to the network address of server 148, or to handle any messages received at plug-in manager 304 that are formatted according to a specific protocol known to be employed by server 148. Other mechanisms for registering plug-ins 216 and associating certain types of messages with each plug-in 216 will also occur to those skilled in the art.

As will be seen in greater detail below, the execution of core policy application 212 and plug-ins 216 configures policy server 116 to provide gateway server 112 for rules amenable to supporting VoIP call sessions even when the originating network element is an element such as server 148 that would normally be unable to initiate such sessions.

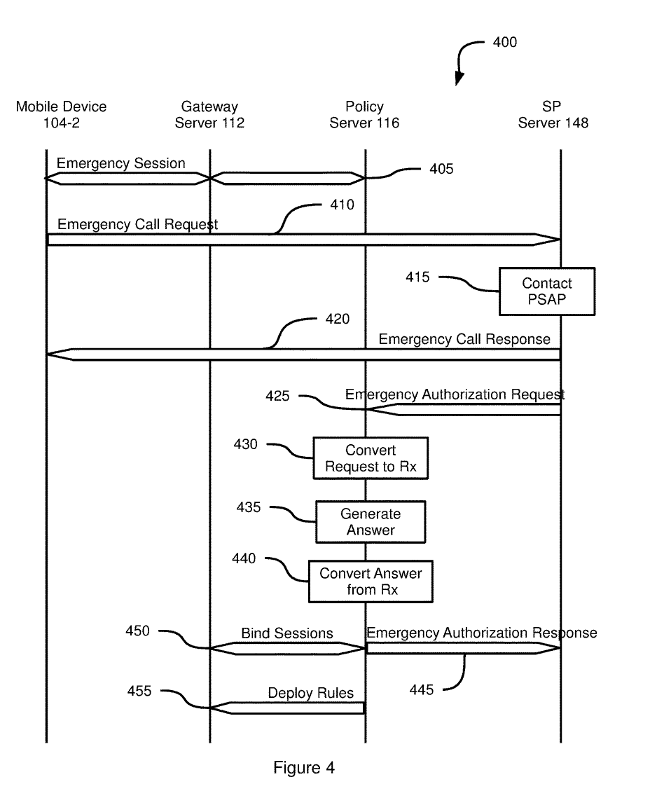

Turning now to FIG. 4, a method 400 of establishing an emergency call for a mobile device is depicted. Method 400 will be discussed in conjunction with its performance in system 100, although it will be appreciated that method 400 may also be performed on variations of system 100, as well as other communications systems.

The performance of method 400 begins at step 405, at which mobile device 104-2 initiates an emergency communication session with gateway server 112. The establishment of an emergency session at step 405 my be accomplished using conventional techniques, and is therefore not described in detail herein. The arrow in FIG. 4 indicating session establishment at step 405 is indicated as two sub-arrows, as policy server 116 may also be involved in such establishment. Briefly, mobile device 104-2 transmits an emergency session request to gateway server 112 (via access network hardware). Gateway server 112 is configured to request and receive rules for the emergency session from policy server 112, for example by sending a “Credit Control Request” message (not shown) to policy server 116 and receiving a “Credit Control Answer” message from policy server 116.

It will now be apparent to those skilled in the art that the emergency session established between mobile device 104-2 and gateway server 112 will have a “best effort” quality of service (QoS) level associated with it. Such a QoS level is insufficient for supporting voice or video calls. Further manipulations of the emergency session are required in order to support the emergency call.

Once the emergency session is established, at step 410 mobile device 104-2 is configured to transmit an emergency call request to server 148, via gateway server 112 (over the emergency session established at step 405).

At step 415, server 148, in response to receiving the emergency call request from mobile device 104-2, is configured to contact an appropriate PSAP. For example, server 148 may select and contact PSAP 140 based on the current location of mobile device 104-2. The selection of a PSAP, and the creation of a communications session between the PSAP and server 148, are performed conventionally and therefore are not described in detail herein.

At step 420, server 148 transmits an emergency call response to mobile device 104-2 via links 136-2 and 128-2. In the present embodiment, the emergency call response message indicates to mobile device 104-2 that the emergency call request was received, and that a call is being set up. In other embodiments, the emergency call response can be sent before the performance of step 415. In further embodiments, the emergency call response can instead be sent only after the emergency call has been established successfully.

At step 425, server 148 transmits an emergency authorization request message to policy server 116 over link 152. To reiterate, server 148 does not support the Rx protocol required by the 3GPP standards. Instead, the message sent at step 425 can be structured according to any of a variety of other protocols, such as HTTP, SIP, or a proprietary protocol. In the present example, it is contemplated that the emergency authorization request contains the following fields:

{Session Id}—an identifier of the session established between server 148 and PSAP 140;

{AF Id}—an identifier of server 148, such as a network address (e.g. IP address, MAC address);

{IMEI}—International Mobile Equipment Identity, an identifier of mobile device 104-2;

{Framed IP Address}—a network address of mobile device 104-2; and

{Service URN}—a parameter that identifies the request as a request for emergency services; this may also identify the specific emergency services required (e.g. police, fire, ambulance).

The above contents of the emergency authorization request are exemplary, and other fields may also be employed. In general, the emergency authorization request identifies server 148, mobile device 104-2, and indicates that it is an emergency request.

Having received the emergency authorization request, at step 430 policy server 116 executes core policy application 112 to generate an internal request message from the emergency authorization request. In the present embodiment, the internal request message is an Rx-based message referred to as an AA-Request message (AAR). Policy server 116 is configured to select a plug-in 216 to perform the conversion. For example, policy server 116 may execute plug-in manager 304 to compares the incoming emergency authorization request with the registration records mentioned above, and based on that comparison select plug-in 216-1 to handle the incoming message.

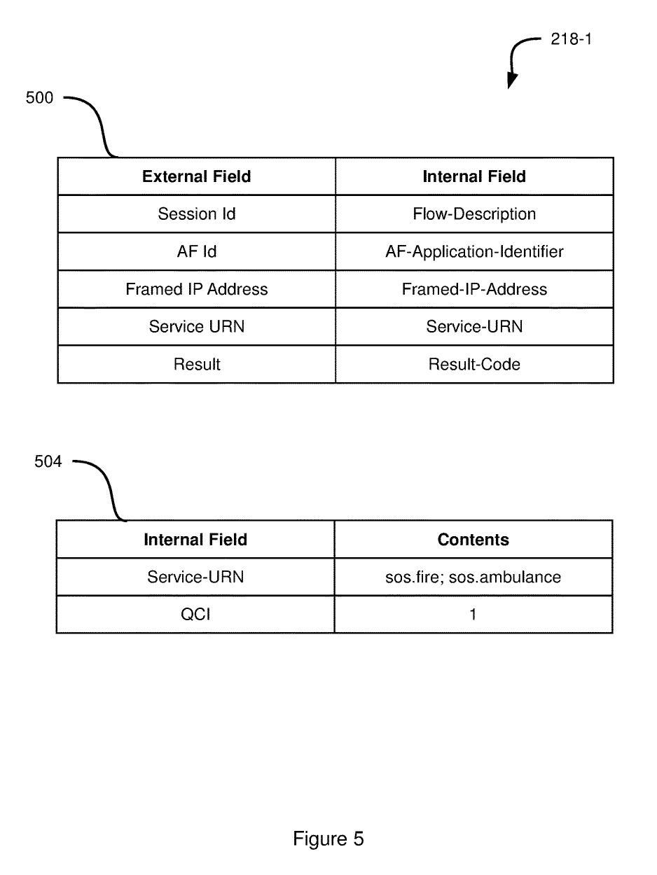

Policy server 116 thus executes plug-in 216-1 to convert the emergency authorization request into the internal message, which in the present embodiment is an Rx-based AAR message. The conversion is performed based on configuration data 218-1, an example of which is shown in FIG. 5.

Turning to FIG. 5, two portions of configuration data 218-1 are shown. A first portion 500 contains mappings of “external fields” (that is, fields of the emergency authorization request mentioned above) to “internal fields” (that is, fields specified by the Rx protocol which policy server 116 is able to process via execution of rule generation module 300. A second portion 504 of configuration data 218-1 defines the contents of certain fields for the internal request message. The second portion 504 is preconfigured for server 148, and allows policy server 116 to retrieve certain parameters even when they have not been received from server 148. Thus, second portion 504 contains service provider-specific parameters (for example, a different set of emergency services can be specified based on the nature of services provided by server 148).

Returning to FIG. 4, at step 430 policy server 116 (via execution of plug-in 216-1) is configured to compare the fields in the emergency authorization request to portion 500 of configuration data 218-1, and to place the contents of each field in the corresponding “internal” field identified in portion 500. In addition, policy server 116 can be configured to supplement the data in the emergency authorization request with the data provided in portion 504 of configuration data 218-1.

When the internal request message has been generated by plug-in 216-1, the internal request message is passed via plug-in manager (or other suitable mechanisms) to rule generation module 300. Policy server 116 is thus configured, at step 435, to evaluate the internal request message and generate an internal answer to the internal request message. The evaluation is not particularly limited, and can include at least verifying that the identifier of server 148 in the internal request message is present in a list of authenticated (or “trusted”) Application Functions stored in memory 204. The evaluation can also include confirming that a Service URN parameter is present in the internal request message, indicating that the request is for emergency services—mobile device 104-2 may only be permitted to establish voice or video calls for emergency services, and thus if a voice or video call is being requested that is not identified as being an emergency call, policy server 116 may deny the call.

If either of the above evaluations fail, policy server 116 is configured to generate a negative internal answer, denying establishment of the emergency call. However, if the evaluations succeed, policy server 116 is configured to generate an affirmative internal answer, granting establishment of the emergency call.

At step 440, policy server 116 is configured to convert the internal answer generated at step 435 to an “external” answer in a format that is supported by server 148. In other words, the conversion at step 440 is the reverse of the conversion at step 430. Specifically, the internal answer generated via the execution of rule generation module 300 is passed, via plug-in manager module 304 or other suitable mechanisms, to plug-in 216-1. Policy server 116 is then configured, by executing plug-in 216-1, to map the internal (e.g. Rx) fields back to fields understood by server 148. As such, policy server 116 can again consult portion 500 to map internal fields to external fields.

At step 445, policy server 116 is configured to transmit the answer message generated at step 440 to server 148. An example emergency authorization response message sent at step 445 contains the following fields:

{Session Id}—an identifier of the session established between server 148 and PSAP 140; and

{Framed IP Address}—a network address of mobile device 104-2; and

{Result}—an indication of whether the evaluations at step 435 were successful or not.

As noted earlier, the above message contents are provided by way of example, and a wide variety of other suitable response messages may be employed, depending on the particular protocols supported by server 148.

At step 450, following the successful evaluations at step 435 policy server 116 is configured to send an inquiry to gateway server 112 to determine whether a session exists between gateway server 112 and mobile device 104-2. If such a session is not found, method 400 ends and a failure message is returned to server 148 (and then from server 148 to mobile device 104-2). However, if such a session is found—and in the present example, such a session was indeed established at step 405—then policy server 116 is configured to bind the session between mobile device 104-2 and gateway server 112 with the session between server 148 and PSAP 140.

Policy server 116 is also configured, at step 455, to generate and deploy rules to gateway server 112 defining the service parameters for the emergency call. The deployment of rules may be accomplished by way of a Re-Auth-Request (RAR) message from policy server 116 to gateway server 112. Gateway server 112 may respond with a Re-Auth-Answer (RAA) message—both RAR and RAA messages are defined by the Diameter protocol (specifically, the Gx implementation of the Diameter protocol). Those service parameters include QoS parameters that elevate the priority of the call's traffic to a level that supports voice or video calling. In some embodiments, the QoS parameters provided to gateway server 112 match those stored in configuration data 218-1. Steps 450 and 455 can be performed simultaneously in some embodiments.

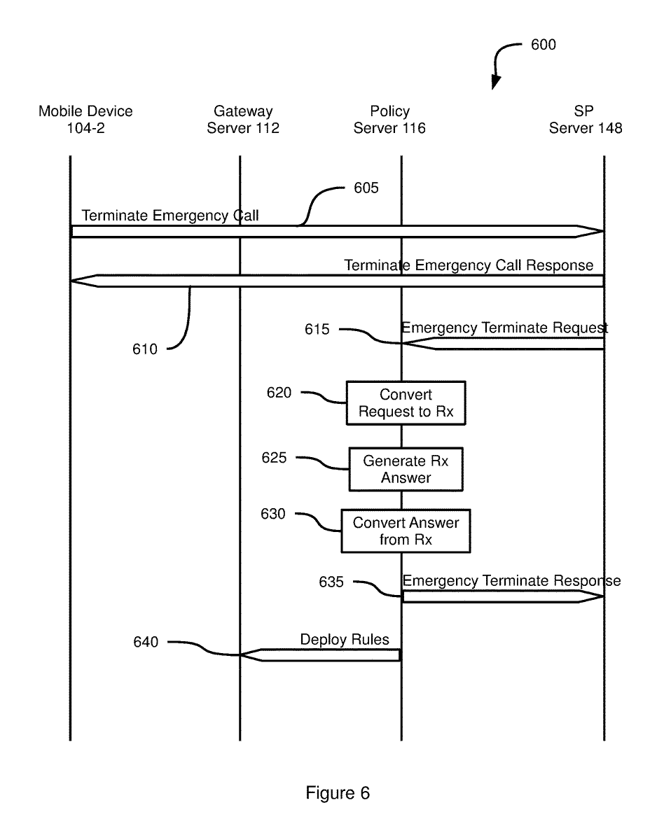

When the emergency call is to be terminated, a similar process as that described above is performed. Turning to FIG. 6, a method 600 of terminating an emergency call is depicted. As with method 400, method 600 will be described in conjunction with its performance in system 100, although method 600 can also be performed in other systems.

Beginning at step 605, mobile device 104-2 is configured to send a terminate emergency call request to server 148, via gateway server 112. Such a message may be sent in response to a user input at mobile device 104-2 instructing mobile device 104-2 to hang up.

At step 610, server 148 confirms receipt of the termination request received from mobile device 104-2. The termination response sent from server 148 to mobile device 104-2 at block 610 may also be sent only after successful termination of the call, in other embodiments.

At step 615, server 148 is configured to send an emergency termination request message to policy server 116. The emergency termination request, in the present example, includes the following fields, although it is reiterated that these are examples only:

{Session Id}—an identifier of the session established between server 148 and PSAP 140;

{AF Id}—an identifier of server 148, such as a network address (e.g. IP address, MAC address);

{IMEI}—International Mobile Equipment Identity, an identifier of mobile device 104-2; and

{Framed IP Address}—a network address of mobile device 104-2.

At steps 620, 625 and 630, policy server 116 is configured to receive the termination request from server 148, convert the termination request to an internal format such as Rx, generate an answer to the termination request, and convert the answer from the internal format to the external format supported by server 148. Steps 620, 625 and 630 are performed in substantially the same manner as steps 430, 435 and 440 as described above.

At step 635, policy server 116 is configured to transmit the converted termination response to server 148. An example of such a response contains the following fields:

{Session Id}—an identifier of the session established between server 148 and PSAP 140; and

{Framed IP Address}—a network address of mobile device 104-2; and

{Result}—an indication of whether the termination of the call was successful or not.

Having delivered the termination response at block 635, policy server 116 is configured to then generate and deploy updated rules to gateway 112 for the session between mobile device 104-2 and gateway server 112. In the present example, policy server 116 is configured to replace the high-priority QoS parameters implemented at step 455 with lower-priority parameters, such as reducing the QoS to “best effort”.

According to the performance of methods 400 and 600 as described above, the establishment and termination of emergency calls is enabled between mobile device 104-2 and PSAP 140, despite the service provider of mobile device 104-2 (server 148) being unable to communicate with policy server 116 according using the mandated Rx protocol.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

1. A method of establishing an emergency call at a policy control server, comprising:
receiving an emergency authorization request, for establishing an emergency call by a mobile device, from a service provider server in an external format;
converting the emergency authorization request to an internal request message having an internal format;
processing the internal request message to generate an internal answer message having the internal format, the internal answer message indicating whether the emergency call is permitted or denied;
converting the internal answer message to an emergency authorization response message having the external format;
transmitting the emergency authorization response message to the service provider server; and
when the emergency call is permitted, deploying one or more policy rules to a gateway server.

2. The method of claim 1, wherein the external format is a first protocol, and wherein the internal format is a second protocol.

3. The method of claim 2, wherein the first protocol is one of Session Initiation Protocol (SIP), Hypertext Transfer Protocol (HTTP), and Simple Object Access Protocol (SOAP).

4. The method of claim 2 or claim 2. the second protocol is Rx.

5. The method of claim 1, further comprising:
storing configuration data defining a mapping between fields of the emergency authorization request and fields of the internal request message;
wherein converting the emergency authorization request comprises inserting the contents of a first field of the emergency authorization request into a second field of the internal request message according to the mapping.

6. The method of claim 1, further comprising:
storing supplemental data;
wherein converting the emergency authorization request further comprises supplementing the internal request message with the supplemental data.

7. The method of claim 1, wherein converting the emergency authorization request comprises executing a plug-in application corresponding to the external format.

8. The method of claim 1, further comprising:
storing a list of authorized service providers;
wherein processing the internal request message includes determining whether an identifier of the service provider service matches one of the authorized service providers.

9. A policy server for establishing an emergency call, comprising:
a network interface;
a memory; and
a processor interconnected with the network interface and the memory, the processor configured to:
receive an emergency authorization request for establishing an emergency call by a mobile device, from a service provider server via the network interface in an external format;
convert the emergency authorization request to an internal request message having an internal format;
process the internal request message to generate an internal answer message having the internal format, the internal answer message indicating whether the emergency call is permitted or denied;
convert the internal answer message to an emergency authorization response message having the external format;
transmit the emergency authorization response message to the service provider server via the network interface; and
when the emergency call is permitted, deploy one or more policy rules to a gateway server.

10. The policy server of claim 9, wherein the external forma s a first protocol, and wherein the internal format is a second protocol.

11. The policy server of claim 10, wherein the first protocol is one of Session Initiation Protocol (SIP), Hypertext Transfer Protocol (HTTP), and Simple Object Access Protocol (SOAP).

12. The policy server of claim 10, wherein the second protocol is Rx.

13. The policy server of claim 10, the memory storing storing configuration data defining a mapping between fields of the emergency authorization request and fields of the internal request message; the processor further configured to:
convert the emergency authorization request by inserting the contents of a first field of the emergency authorization request into a second field of the internal request message according to the mapping.

14. The policy server of claim 10, the memory storing supplemental data; the processor further configured to:
convert the emergency authorization request by supplementing the internal request message with the supplemental data.

15. The policy server of claim 10, the processor configured to convert the emergency authorization request by executing a plug-in application corresponding to the external format.

16. The policy server of claim 10, the memory storing a list of authorized service providers; the processor further configured to:
process the internal request message by determining whether an identifier of the service provider service matches one of the authorized service providers.

17. A non-transitory computer readable medium storing a plurality of computer-readable instructions executable by a processor of a policy server for implementing the method of claim 1.
